(19) United States
(12) Patent Application Publication
(10) Pub. No.: US 2010/0064274 A1
(43) Pub. Date: Mar. 11, 2010

(54) PROXIMITY CORRECTION METHOD AND SYSTEM

(75) Inventor: Wolfgang Grimm, Stockdorf (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Munchen (DE)

(21) Appl. No.: 12/205,006

(22) Filed: Sep. 5, 2008

(51) Int. Cl. G06F 17/50; G03B 27/54

(52) U.S. Cl. 716/21; 355/67

(57) ABSTRACT

A proximity correction method includes creating a first proximity correction model having a focus value and creating a second proximity correction model having a first defocus value. One of the first or second proximity correction models are associated with corresponding first and second layout areas of a semiconductor wafer.

### BACKGROUND

The present disclosure relates generally to the field of semiconductor device manufacture and more particularly to proximity correction such as optical proximity correction (OPC).

The production of semiconductor devices, such as integrated circuit (IC) structures, often relies on photolithographic processes, or photolithography. Such processes typically involve projecting a circuit design from a mask, through a lens system that shrinks the image, and onto a semiconductor wafer that will later be singulated into individual chips. These circuits contain tiny structures, and in some instances, the line widths and the separation between lines is smaller than the wavelength of the light used to print them.

OPC has been used to improve image fidelity. OPC processes involve running a computer simulation that takes an initial data set having information regarding the desired image pattern and manipulates the data set to arrive at a corrected data set in an attempt to compensate for the above-mentioned concerns. Rule-based OPC uses fixed rules for geometric manipulation of the data set, and model-based OPC uses predetermined behavior data to drive geometric manipulation of the data set. Hybrids of rule-based OPC and model-based OPC are also employed.

The data for the determination of the OPC data are created using test masks, which contain typical test-structures in one layout level. The topology of this level is assumed to be planar. In reality, however, chip layers rarely are perfectly planar; but instead, they have a varying topology. Since the models used to determine the OPC data are based on a planar topology, the OPC process is not optimal when applied to a non-planar surface.

For these and other reasons, there is a need for the present invention.

### SUMMARY

In accordance with aspects of the present invention, a proximity correction method includes creating a first proximity correction model having a focus value and creating a second proximity correction model having a first defocus value. One of the first or second proximity correction models are associated with corresponding first and second layout areas of a semiconductor wafer.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a block diagram conceptually illustrating a photolithography system in accordance with disclosed embodiments.

FIG. 2 is a side view conceptually illustrates an ideal layer of a semiconductor wafer.

FIG. 3 is a side view conceptually illustrates multiple layers of a semiconductor wafer.

FIG. 4 illustrates a prior art OPC process.

FIG. 5 illustrates an OPC process using a plurality of OPC models in accordance with disclosed embodiments.

FIG. 6 is a top view conceptually illustrating classifications of a semiconductor wafer layer.

### DETAILED DESCRIPTION

In the following Detailed Description, reference is made to the accompanying drawings, which form a part hereof, and in which is shown by way of illustrating specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

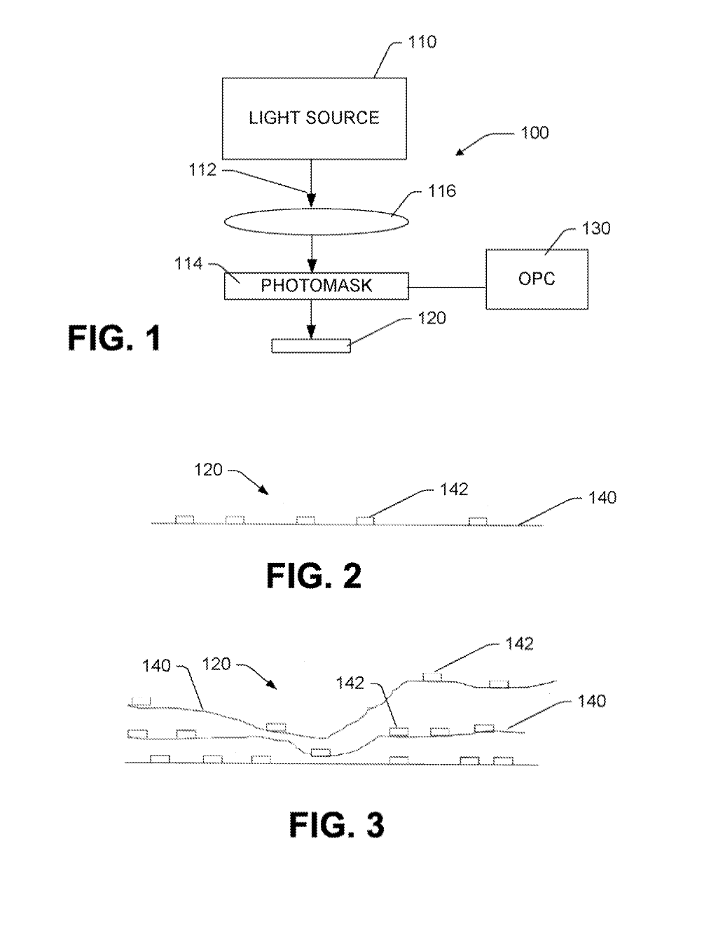

FIG. 1 is a block diagram conceptually illustrating a system 100 for producing semiconductor devices in accordance with disclosed embodiments. In the system 100, circuit designs or patterns are transferred onto a substrate. In some embodiments, the system 100 is a photolithography system. Other embodiments are envisioned where other processes are used, such as electron beam lithography, for example. In general, photolithography is an optical process for transferring patterns onto a substrate. The patterns are first transferred to an imagable photoresist layer, which is a liquid film that can be spread out onto the substrate, exposed with the desired pattern, and developed into a selectively placed layer for subsequent processing.

A light source 110 projects light 112 through a reticle, or photomask 114 and a lens system 116 to a layer of a semiconductor wafer 120 upon which a circuit pattern is to be produced. The lens system 116 shrinks the image from the photomask 114 so that the circuit design established by the photomask 114 can fit on the wafer 120. The wafer 120 is coated with an imagable photoresist layer to which the patterns are first transferred. The photoresist is a liquid film that can be spread out onto the wafer 120, exposed with the desired pattern established by the photomask 114, and developed into a selectively placed layer for subsequent processing. The photoresist can be applied by a spin coating process, for example.

The system 100 includes a proximity correction module 130. In embodiments employing a photolithography system, the proximity correction module performs an optical proximity correction (OPC) process, which functions to improve the quality of the integrated circuit production process. Typically, the features to be projected to the wafer 120 from the photomask 114 are very small. The circuit designs contain tiny structures, such as metal and polysilicon lines, which sometimes are smaller than the wavelength of the light used to print them. Inherent limitations of the lens system 116 can result in inaccurate transfer of the pattern from the photomask 114. For example, stray light entering an opening from one shape could enter an opening from another shape in close proximity, leading to a complex interaction of the electric fields of adjacent polygons. This can result in the final shapes having rounded corners or portions that extend towards adjacent shapes, possibly shorting together and rendering the chip defective.

The OPC process modifies the shapes that are drawn by the designers to compensate for the non-ideal properties of the photolithography process. Based on the final shapes desired on the wafer 120, the photomask 114 is modified using the OPC module 130 to improve the reproduction of the critical geometry. Edges of the shapes are divided into small segments which are repositioned and shapes are added or removed at particular locations in the layout. The addition of these OPC structures to the mask layout allows for tighter design rules and improves process quality and reliability and yield. The OPC module 130 can be implemented by a suitably programmed processing device and associated memory, etc.

OPC techniques include rule-based and model-based OPC. With rule-based OPC, different geometries are treated by different, typically predetermined rules. Model-based OPC involves simulation or modeling various aspects of production processes, such as the photolithography effects, etching effects, mask effects, etc. For instance, to determine the OPC structures, the circuit pattern is calculated using a simulation model of the photolithographic projection that results during imaging onto the resist layer of the semiconductor wafer. Known modeling processes, however, assume the wafer surface is planar, as conceptually illustrated in FIG. 2, where a wafer surface 140 is flat with structures 142 on the surface 140. Even though the prepared wafer surface is generally flat, variations in the wafer topography exist, as illustrated in FIG. 3, where layers 140 of the wafer have a varying topography (exaggerated).

The distance between the photomask 114 and the surface 140 of the wafer 120 is referred to as the focus. In accordance with embodiments of the invention, a first OPC model is created using the OPC module 130, for example, based on a circuit layout, having a given focus value. For creation of the first OPC model, no variation in the wafer topology is assumed, such as illustrated in FIG. 2.

A plurality of additional OPC models are then generated based on a corresponding plurality of defoci from the focus of the first OPC model. In some embodiments, all of the OPC models are stored in memory devices that are accessible by the OPC module. For example, one OPC model can be created having a first defocus from the first OPC model, and another OPC model can be created having a second defocus value. The first defocus could be positive and the second defocus could be negative, for example. The various areas layout areas of the substrate 120 are assigned to a corresponding plurality of classes, and the OPC models are associated with corresponding classes.

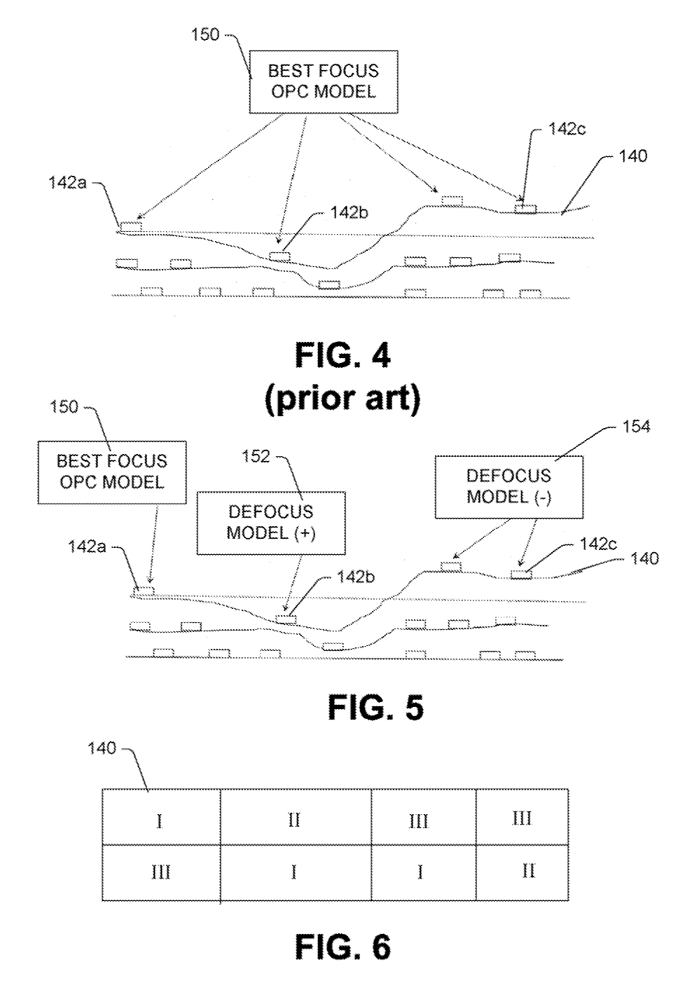

FIG. 4 illustrates a prior art OPC process, where only one OPC model 150—the “best focus” model—is used to generate OPC data for all structures 142 of the illustrated top layer 140, even though the layer 140 is not actually flat. As illustrated in FIG. 4, the structure 142a is positioned at the simulated best focus distance, but due to variations in topology of the layer 140, the structure 142b is below the level of the structure 142a, and the structure 142c is above the structure 142a.

In accordance with disclosed embodiments, as illustrated in FIG. 5, the first OPC model 150, which is based on an “ideal” planar substrate, is used for generating OPC data for structures 142a in a first class of topology. A second OPC model 152 that has a positive defocus is used for structures 142b in a second area of the layer 140, and another model 154 having a negative defocus is used for structures 142c in another layout area.

Thus, the different OPC models 150,152,154, etc. are associated with corresponding layout areas of the layer 140 of the wafer 120. In some embodiments, this process includes assigning the layout areas of the layer 140 to different classifications. FIG. 5 illustrates three classifications of layout areas, though any suitable number of classifications and corresponding defocus models can be used. FIG. 6 conceptually illustrates an example of layout classifications, where the various areas of the layer 140 are assigned to classification I, II or III. Each of the classifications is associated with a corresponding OPC model, such as the best focus model 150 and appropriate additional defocus models.

In some embodiments, a topology map of the substrate is created, and based on the topology map, the layer 140 is divided into various topology classifications. The topology map can be created, for example, using mathematical models of the Chemical Mechanical Polishing (CMP) process. The CMP process is used to make the wafer 120 relatively flat and smooth before structures and additional layers are added. As noted above, while the CMP process results in a relatively planar wafer surface, the resulting surface is not perfectly flat and exhibits variations in topology. Polishing the wafer uniformly is difficult, for instance, because the various materials deposited on the wafer have different chemical and mechanical characteristics and are affected at different rates. The problem is further complicated by the mechanical properties of the wafer and the polishing pad, such as their elasticity. Programs for modeling the CMP process are commercially available, for example, from Cadence Design Systems of San Jose, Calif.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A proximity correction method, comprising:
creating a first proximity correction model having a focus value;
creating a second proximity correction model having a first defocus value; and
associating one of the first or second proximity correction models with corresponding first and second layout areas of a semiconductor wafer.

2. The method of claim 1, further comprising creating a third proximity correction model having a second defocus from the first proximity correction model.

3. The method of claim 2, wherein the first defocus is a positive defocus.

4. The method of claim 2, wherein the second defocus is a negative defocus.

5. The method of claim 1, further comprising creating a topology map of the substrate.

6. The method of claim 7, wherein creating the topology map includes modeling a chemical mechanical polishing process.

7. The method of claim 1, further comprising assigning a plurality of layout areas of the semiconductor wafer to a corresponding plurality of classes.

8. The method of claim 5, further comprising assigning a plurality of layout areas of the semiconductor wafer to a corresponding plurality of classes using the topology map.

9. The method of claim 1, further comprising generating proximity correction data for creating a photomask based on the first and second proximity correction models.

10. The method of claim 1, wherein the first and second proximity correction models are optical proximity correction models.

11. A proximity correction system, comprising:
a first proximity correction model having a focus value;
a second proximity correction model a first defocus from the first proximity correction model;
wherein the first and second proximity correction models are associated with corresponding layout areas of a semiconductor wafer.

12. The system of claim 11, wherein the proximity correction system is programmed to create a topology map of the semiconductor wafer.

13. The system of claim 12, wherein creating the topology map includes modeling a chemical mechanical polishing process.

14. The system of claim 11, further comprising a third proximity correction model having a second defocus from the first proximity correction model.

15. The system of claim 11, wherein the first defocus is a positive defocus.

16. The system of claim 11, wherein the second defocus is a negative defocus.

17. The system of claim 11, wherein the first and second proximity correction models are optical proximity correction models.

18. A system, comprising:
a light source;
a photomask;
a lens receiving light from the light source and adapted to project an image from the photomask to a semiconductor wafer; and
an optical proximity correction module including:
a first OPC model having a focus value;
a second OPC model a first defocus from the first OPC model;
wherein the first and second OPC models are associated with corresponding layout areas of the semiconductor wafer.

19. The system of claim 18, wherein the OPC model includes a third OPC model having a second defocus from the first OPC model.

20. The system of claim 18, wherein the first defocus is a positive defocus.

21. The system of claim 18, wherein the second defocus is a negative defocus.

22. A proximity correction system, comprising:
means for creating a first proximity correction model having a focus value;
means for creating a second proximity correction model having a first defocus value; and
means for associating one of the first or second proximity correction models to corresponding first and second layout areas of a semiconductor wafer.
